(19) United States
(12) Patent Application Publication
(10) Pub. No.: US 2014/0083113 A1
(43) Pub. Date: Mar. 27, 2014

(54) FLOW CONTROL TAB FOR TURBINE SECTION FLOW CAVITY

(71) Applicant: GENERAL ELECTRIC COMPANY, Schenectady, NY (US)

(72) Inventor: John Ellington Greene, Greenville, SC (US)

(73) Assignee: GENERAL ELECTRIC COMPANY, Schenectady, NY (US)

(21) Appl. No.: 13/628,411

(22) Filed: Sep. 27, 2012

(51) Int. Cl. F02C 7/00; F01D 25/12; F02C 3/04; F01D 1/04

(52) U.S. Cl. 60/805; 415/208.1; 415/115

(57) ABSTRACT

Flow control tabs for turbine sections are provided. The turbine section includes a stator assembly and a rotor assembly. The rotor assembly includes a bucket, the bucket having a shank. The rotor assembly and the stator assembly are spaced apart along a longitudinal axis and defining a flow cavity therebetween such that a cooling fluid flows therein. The flow control tab includes a mount surface configured for mounting to the stator assembly, a radially outer surface, a radially inner surface, and a leading edge. The leading edge connects the outer surface and the inner surface such that cooling fluid interacting with the leading edge is divided into an outer purge flow and an inner recirculation flow.

### FIELD OF THE INVENTION

The present disclosure relates in general to turbomachines, and more particularly to flow control apparatus for flow cavities in turbine sections of turbomachines.

### BACKGROUND OF THE INVENTION

Gas turbine systems are one example of turbomachines widely utilized in fields such as power generation. A conventional gas turbine system includes a compressor section, a combustor section, and a turbine section. During operation of the gas turbine system, various components in the system are subjected to high temperature flows, which can cause the components to fail. Since higher temperature flows generally result in increased performance, efficiency, and power output of the gas turbine system, the components that are subjected to high temperature flows should be cooled to allow the gas turbine system to operate at increased temperatures.

During operation of a turbomachine, air or another suitable fluid may be compressed in a compressor section of the turbomachine. While some of this fluid is then supplied to the combustor section for combustion therein and flow through hot gas paths of the combustor section, other portions of the fluid are redirected for use in, for example, cooling various portions of the turbomachine. In particular, cooling fluid may be flowed into flow cavities (also known as wheel space cavities) between the various stator assemblies and rotor assemblies (which include the various respective nozzles and buckets) in the turbine section. This cooling flow is provided to cool the stator and rotor assemblies, and to prevent ingestion of hot gas flow out of the hot gas path that is further defined in the turbine section.

In current turbine section designs, however, it has been discovered that hot gas flow ingestion may occur at higher than desired levels. In particular, the present inventors have discovered that the flow fields in flow cavities of current turbine sections may not be sufficient to adequately reduce hot gas flow ingestion to desired levels.

Accordingly, improved apparatus for reducing hot gas flow ingestion and increasing cooling in turbine section flow cavities would be desired in the art. In particular, apparatus for modifying cooling fluid flow fields in flow cavities such that the cooling fluid is redirected to reduce hot gas flow ingestion and increase cooling would be advantageous.

### BRIEF DESCRIPTION OF THE INVENTION

Aspects and advantages of the invention will be set forth in part in the following description, or may be obvious from the description, or may be learned through practice of the invention.

In one embodiment, a flow control tab for a turbine section is disclosed. The turbine section includes a stator assembly and a rotor assembly. The rotor assembly includes a bucket, the bucket having a shank. The rotor assembly and the stator assembly are spaced apart along a longitudinal axis and defining a flow cavity therebetween such that a cooling fluid flows therein. The flow control tab includes a mount surface configured for mounting to the stator assembly, a radially outer surface, a radially inner surface, and a leading edge. The leading edge connects the outer surface and the inner surface such that cooling fluid interacting with the leading edge is divided into an outer purge flow and an inner recirculation flow.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic illustration of a gas turbine system;

FIG. 2 is a sectional side view of the turbine section of a gas turbine system according to one embodiment of the present disclosure;

FIG. 3 is a sectional side view of a portion of a turbine section, including a stator assembly, rotor assembly, flow cavity, and flow control tab, according to one embodiment of the present disclosure; and

FIG. 4 is a sectional side view of a portion of a turbine section, including a stator assembly, rotor assembly, flow cavity, and flow control tab, according to another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

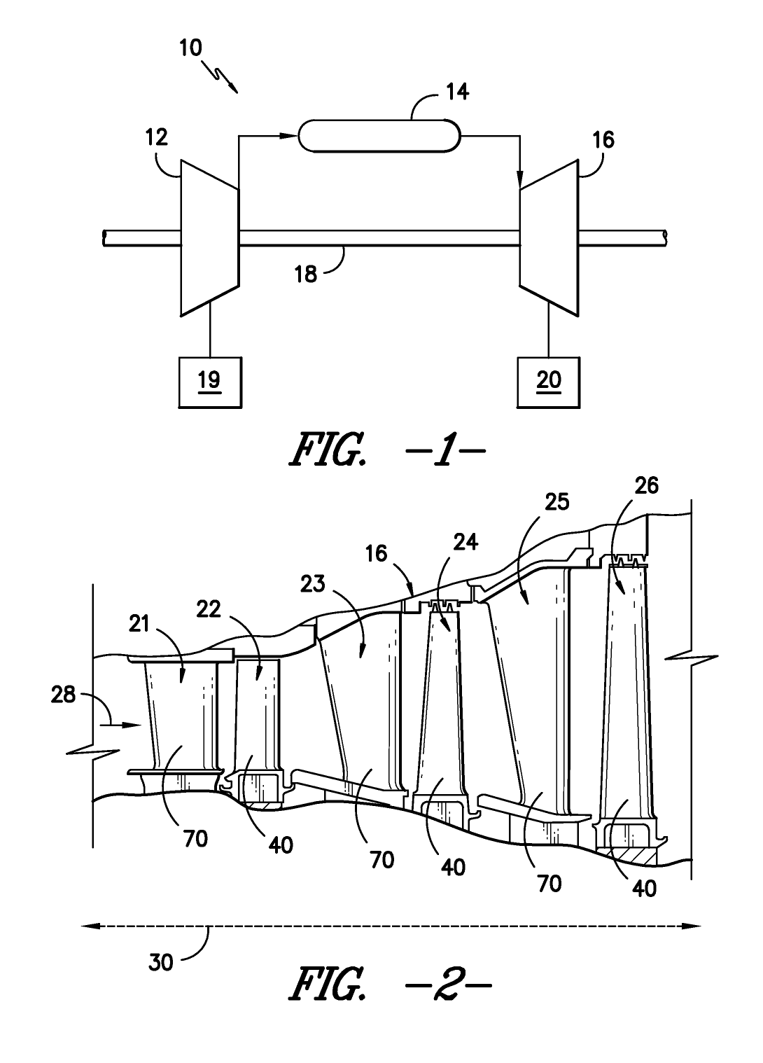

FIG. 1 is a schematic diagram of a turbomachine, which in the embodiment shown is a gas turbine system 10. The system 10 may include a compressor section 12, a combustor section 14, and a turbine section 16. The compressor section 12 and turbine section 16 may be coupled by a shaft 18. The shaft 18 may be a single shaft or a plurality of shaft segments coupled together to form shaft 18. An inlet section 19 may provide an air flow to the compressor section 12, and exhaust gases may be exhausted from the turbine section 16 through an exhaust section 20 and exhausted and/or utilized in the system 10 or other suitable system.

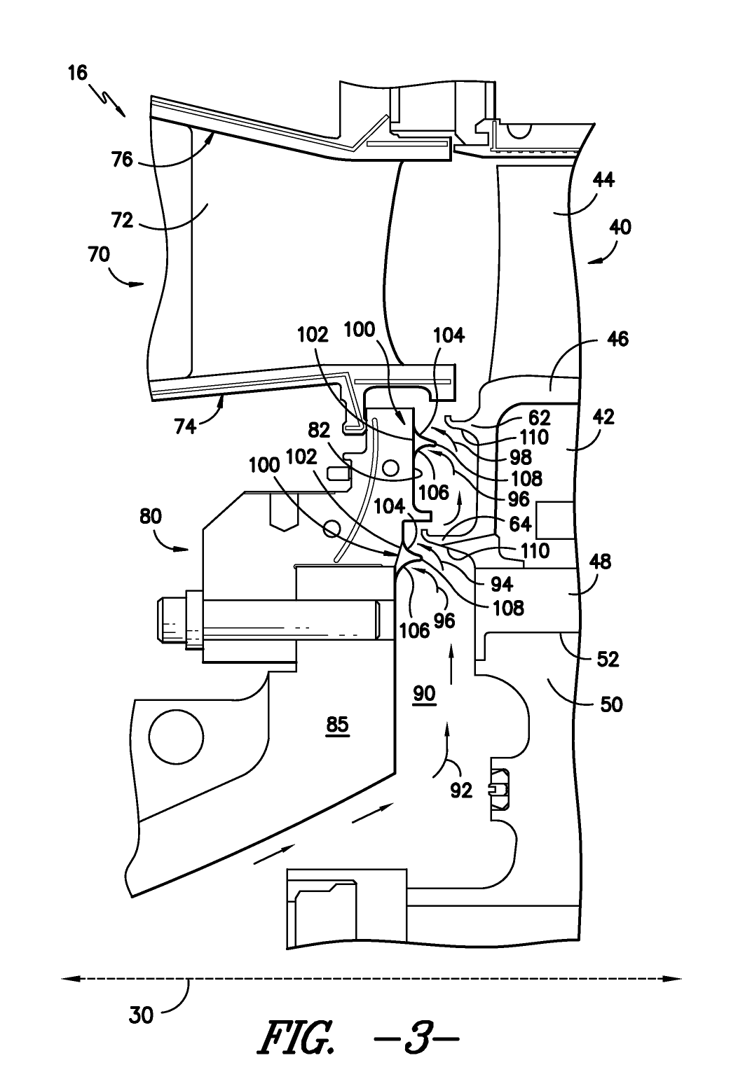

The turbine section 16 may include a plurality of turbine stages. For example, in one embodiment, the turbine section 16 may have three stages, as shown in FIG. 2. For example, a first stage of the turbine 16 may include a plurality of circumferentially spaced stator assemblies 21 and rotor assemblies 22. The stator assemblies 21 may be disposed and fixed circumferentially about the shaft 18. The rotor assemblies 22 may be disposed circumferentially about the shaft 18 and coupled to the shaft 18. A second stage of the turbine section 16 may include a plurality of circumferentially spaced stator assemblies 23 and rotor assemblies 24. The stator assemblies 23 may be disposed and fixed circumferentially about the shaft 18. The rotor assemblies 24 may be disposed circumferentially about the shaft 18 and coupled to the shaft 18. A third stage of the turbine section 16 may include a plurality of circumferentially spaced stator assemblies 25 and rotor assemblies 26. The stator assemblies 25 may be disposed and fixed circumferentially about the shaft 18. The rotor assemblies 26 may be disposed circumferentially about the shaft 18 and coupled to the shaft 18. The various stages of the turbine section 16 may be disposed in the turbine 16 in the path of hot gas flow 28. It should be understood that the turbine section 16 is not limited to three stages, but rather that any number of stages are within the scope and spirit of the present disclosure. Further, the various stages may be generally aligned with respect to one another along a longitudinal axis 30, and may be located upstream and downstream of one another with respect to the direction of hot gas flow 28. For example, first stage stator assemblies 21 are considered upstream of first stage rotor assemblies 22, and first stage rotor assemblies 22 are considered downstream of first stage stator assemblies 21, along the longitudinal axis 30.

As further shown in FIGS. 2 through 4, each rotor assembly 22, 24, 26 may include a bucket 40. A bucket 40 may generally include a shank 42 and an airfoil 44. The airfoil 44 may be positioned and extend radially outward of the shank 42, as shown. Additionally, the bucket 40 may include a platform 46. The platform 46 may be positioned radially between, and may further surround one or both of, the shank 42 and/or airfoil 44. Further, the bucket 40 may include a dovetail 48. The dovetail 48 may extend radially inward from the shank 42, and in some embodiments be a radially inward portion of the shank 42. The dovetail 48 may be configured for coupling the bucket 40 to a rotor wheel 50. A rotor assembly 22, 24, 26 may additionally include a rotor wheel 50, which may include a dovetail cavity 52 in which the dovetail 48 may fit and thus be coupled.

The shank 42 may in some embodiments additionally include one or more angel wings. For example, one or more upstream angel wings and one or more downstream angel wings may be provided on a shank 42. As shown, an upstream upper angel wing 62 and an upstream lower angel wing 64 may be provided. A downstream upper angel wing and a downstream lower angel wing may additionally be provided. It should be understood that a shank 42 may include no angel wings, or any one or more angel wings such as those discussed above.

As further shown in FIGS. 2 through 4, each stator assembly 21, 23, 25 may include a nozzle 70. The nozzle may include one or more airfoils 72, a radially inner sidewall 74, and a radially outer sidewall 76. The airfoil 72 may extend between the inner and outer sidewalls 74, 76 and be connected thereto.

A stator assembly 21, 23, 25 may further include a support ring 80. The support ring 80 may support and seal with the nozzle 70. As shown, a support ring 80 may include various sidewalls, including a longitudinally downstream sidewall 82. In some embodiments, a stator assembly may further include a compressor discharge casing 85. The support ring 80 may be mounted to the compressor discharge casing 85.

Associated stator assemblies and rotor assemblies, such as first stage stator assemblies 21 and rotor assemblies 22, second stage stator assemblies 23 and rotor assemblies 24, third stage stator assemblies 25 and rotor assemblies 26, etc., may define flow cavities 90 therebetween. A cooling fluid 92, such as compressor discharge air or another suitable gas, may be flowed through the flow cavity 90. As discussed, in previously known turbomachines, a portion of the cooling fluid 92 escaped between the associated stator assemblies and rotor assemblies into the path of hot gas flow 28, and a portion of hot gas flow 28 was ingested into the flow cavity 90, thus causing losses and inefficiencies.

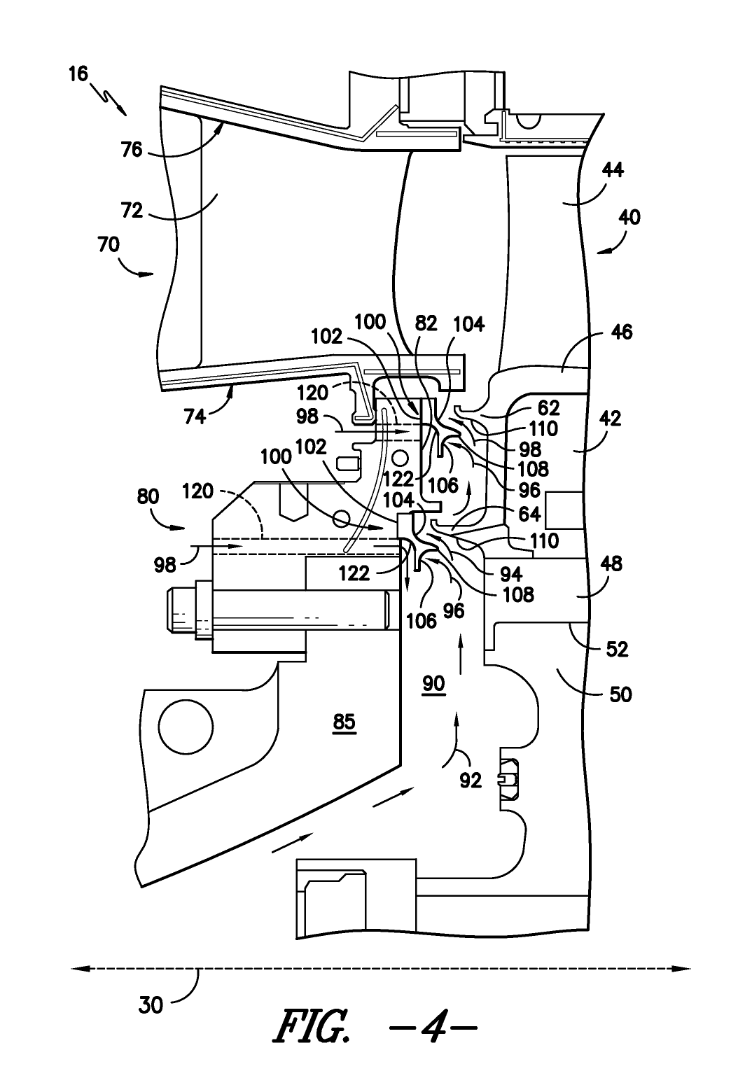

Thus, the present disclosure is further directed to flow control tabs 100, as shown in FIGS. 3 and 4. A flow control tab 100 according to the present disclosure may be located in the flow cavity, and may direct the flow of cooling fluid 92 within the flow cavity 90, such that portions of the cooling fluid 92 are recirculated within the flow cavity 90 and other portions of the cooling fluid 92 are directed to reduce hot gas flow ingestion. One or more flow control tabs 100 may be provided in a flow cavity 90 to provide such flow direction.

As shown, a flow control tab 100 includes a mount surface 102. The mount surface 102 is configured for mounting to the stator assembly, such as stator assembly 21 as shown. In exemplary embodiments, the mount surface 102 may be configured for mounting to, and mounted to, the support ring 80, and more specifically to the longitudinally downstream sidewall 82. Still further, in some embodiments, a flow control tab 100 may be mounted to a radially outermost portion of a sidewall 82. Alternatively, a flow control tab 100 may be mounted at any suitable location on a sidewall 82, support ring 80, or any suitable component of a stator assembly. FIGS. 3 and 4 each illustrate two tabs 100, one of which is mounted to a radially outermost portion of a sidewall 82 and one of which is mounted to a relatively radially inward portion of the sidewall 82. Mounting of a tab 100 via a mount surface 102 to a stator assembly may be done through the use of mechanical fasteners (nuts-bolt combinations, rivets, screws, nails, etc), welding, or any other suitable mounting apparatus or method. Further, it should be noted that in some embodiments the tab 100 may be integral with the stator assembly, and the mount surface 102 may simply be a portion of the integral component that delineates that tab 100 from the remainder of the stator assembly.

A flow control tab 100 may further include a radially outer surface 104, a radially inner surface 106, and a leading edge 108 connecting the outer surface 104 and the inner surface 106. Cooling fluid 92 that flows into or past, and thus interacts with, the leading edge 108 may be divided into an outer purge flow 94 and an inner recirculation flow 96. The outer purge flow 94 may flow generally radially outwardly towards the hot gas path 28, to prevent hot gas ingestion. The inner recirculation flow 96 may recirculate within the flow cavity 90 to facilitate cooling of the stator assembly and rotor assembly.

In some embodiments, as shown, one or both of the outer surface 104 and/or the inner surface 106 may have curvilinear cross-sectional profiles. A cross-sectional profile according to the present disclosure is a profile viewed as shown in FIGS. 3 and 4. Alternatively, one or both of the outer surface 104 and/or the inner surface 106 may be linear. Further, with respect to curvilinear cross-sectional profiles, in some embodiments a curvilinear cross-sectional profile may be spline shaped.

The outer surface 104 of a tab 100 according to the present disclosure may further in some embodiments be positioned radially inward of an associated angel wing. As shown, for example, the outer surface 104 of a radially outward tab 100 is positioned radially inward of the upstream upper angel wing 62. The outer surface 104 of a radially inward tab 100 is positioned radially inward of the upstream lower angel wing 64. Further, in exemplary embodiments, the outer surface 104 of a tab 100 may have a cross-sectional profile that corresponds to a cross-sectional profile of the associate angel wing, such as to the cross-sectional profile of an outer surface 110 thereof. By so contouring the outer surface 104, the flow of cooling fluid 92, such as the outer purge flow 94, may have a generally uniform pressure and velocity field between the outer surfaces 104 and 110. This may enhance the outer purge flow 94. Similarly, the various above-disclosed contouring of the outer surface 104 and inner surface 106, such as the curvilinear cross-sectional profiles thereof, etc., may be designed to maintain or improve pressure and velocity at these locations, thus enhancing both outer purge flow 94 and inner recirculation flow 96. In exemplary embodiments, for example, modeling software, such as computer aided design and/or finite element analysis software, may be utilized to design the cross-sectional profiles of the various surfaces of the tabs 100, including the outer surface 104 and inner surface 106. Such designs may ensure that the cooling fluid 92 flow is being directed as required to reduce ingestion and control recirculation as required.

In some embodiments, as shown in FIG. 4, one or more bore holes 120 may be defined in a stator assembly, such as in stator assembly 21 as shown. A bore hole 120 may be provided for flowing cooling fluid, as indicated by supplemental flow 98, therethrough to the flow cavity 90. The bore hole 120 may extend generally longitudinally, as shown, or at any suitable angle. Further, the bore hole 120 may be defined in the support ring 80, as shown, or any other suitable component or portion of the stator assembly. The additional injection of supplemental flow 98 into the flow cavity 90 may be provided to energize the cooling fluid 92 in the flow cavity 90, which may experience losses due to turning and preventing ingestion. Thus, the injection of supplemental flow 98 through bore holes 120 may minimize any losses of the cooling fluid 92 in the flow cavity 90.

Further, in some embodiments, as shown in FIG. 4, a flow control tab 100 according to the present disclosure may further include a second radially inner surface 122. The second radially inner surface 122 may, for example, connect and/or be between the mount surface 102 and the first radially inner surface 106. For example, the second radially inner surface 122 may face away from the first radially inner surface 106 along a radial axis therebetween, as shown.

In some embodiments, the second radially inner surface 122 may have a curvilinear cross-sectional profile. Alternatively, the second radially inner surface 122 may be linear. Further, with respect to the curvilinear cross-sectional profile, in some embodiments the curvilinear cross-sectional profile may be spline shaped, as discussed above.

The second radially inner surface 122 may be configured to interact with the cooling fluid, such as supplemental flow 98, being exhausted from an associated bore hole 120. As shown, a bore hole 120 may be positioned in a stator assembly such that it exhausts the supplemental flow 98 at a location radially inward from the mount surface 102. Supplemental flow 98 exhausted from the bore hole 120 may flow into or past, and thus interact with, the second radially inner surface 122. The second radially inner surface 122 may turn the supplemental flow 98 as desired or required. For example, as shown, the second radially inner surface 122 may turn the supplemental flow 98 from, for example, a longitudinal direction to, for example, a radial direction, and/or may generally swirl the supplemental flow 98. Turning of the supplemental flow 98 may advantageously direct the flow such that it mixes with the cooling fluid 92 already in the flow cavity 90 at, for example, a desired location and in, for example, a desired direction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A flow control tab for a turbine section, the turbine section comprising a stator assembly and a rotor assembly, the rotor assembly comprising a bucket, the bucket comprising a shank, the rotor assembly and the stator assembly spaced apart along a longitudinal axis and defining a flow cavity therebetween such that a cooling fluid flows therein, the flow control tab comprising:
a mount surface configured for mounting to the stator assembly;
a radially outer surface;
a radially inner surface; and
a leading edge connecting the outer surface and the inner surface such that cooling fluid interacting with the leading edge is divided into an outer purge flow and an inner recirculation flow.

2. The flow control tab of claim 1, wherein the radially outer surface and the radially inner surface each have a curvilinear cross-sectional profile.

3. The flow control tab of claim 2, wherein each of the curvilinear cross-sectional profiles is a spline-shaped cross-sectional profile.

4. The flow control tab of claim 1, wherein the bucket further comprises an angel wing extending from the shank, and wherein a cross-sectional profile of the radially outer surface corresponds to a cross-sectional profile of the angel wing.

5. The flow control tab of claim 1, wherein the bucket further comprises an angel wing extending from the shank, and wherein the radially outer surface is positioned radially inward of the angel wing.

6. The flow control tab of claim 1, the stator assembly comprising a support ring, and wherein the mount surface is configured for mounting to the support ring.

7. The flow control tab of claim 6, wherein the mount surface is configured for mounting to a longitudinally downstream sidewall of the support ring.

8. The flow control tab of claim 7, wherein the mount portion is configured for mounting to a radially outermost portion of the sidewall.

9. The flow control tab of claim 1, wherein a bore hole is defined in the rotor assembly for flowing cooling fluid therethrough to the flow cavity, and wherein the flow control tab further comprises a second radially inner surface configured to interact with the cooling fluid exhausted from the bore hole.

10. A turbomachine, comprising:
a compressor section;
a combustor section; and
a turbine section, the turbine section comprising:
a stator assembly;
a rotor assembly, the rotor assembly comprising a bucket, the bucket comprising a shank, stator assembly spaced apart from the rotor assembly along a longitudinal axis;
a flow cavity defined between the stator assembly and the rotor assembly such that a cooling fluid flows therein; and
a flow control tab disposed in the flow cavity, the flow control tab comprising:
a mount surface mounted to the stator assembly;
a radially outer surface;
a radially inner surface; and
a leading edge connecting the outer surface and the inner surface such that cooling fluid interacting with the leading edge is divided into an outer purge flow and an inner recirculation flow.

11. The turbomachine of claim 10, wherein the radially outer surface and the radially inner surface each have a curvilinear cross-sectional profile.

12. The turbomachine of claim 11, wherein each of the curvilinear cross-sectional profiles is a spline-shaped cross-sectional profile.

13. The turbomachine of claim 10, wherein the bucket further comprises an angel wing extending from the shank, and wherein a cross-sectional profile of the radially outer surface corresponds to a cross-sectional profile of the angel wing.

14. The turbomachine of claim 10, wherein the bucket further comprises an angel wing extending from the shank, and wherein the radially outer surface is positioned radially inward of the angel wing.

15. The turbomachine of claim 10, the stator assembly comprising a support ring, and wherein the mount surface mounted to the support ring.

16. The turbomachine of claim 15, wherein the mount surface mounted to a longitudinally downstream sidewall of the support ring.

17. The turbomachine of claim 16, wherein the mount portion is mounted to a radially outermost portion of the sidewall.

18. The turbomachine of claim 10, further comprising a bore hole defined in the rotor assembly for flowing cooling fluid therethrough to the flow cavity, and wherein the flow control tab further comprises a second radially inner surface configured to interact with the cooling fluid exhausted from the bore hole.

19. The turbomachine of claim 10, wherein the stator assembly is a first stage stator assembly.

20. The turbomachine of claim 10, wherein the flow control tab is a plurality of flow control tabs.
